(19) United States
(12) Patent Application Publication
(10) Pub. No.: US 2025/0364150 A1
(43) Pub. Date: Nov. 27, 2025

(54) RADIOGRAPHY SOURCES AND RADIATION EXPOSURE DEVICES HAVING TRACKER MODULE HOLDERS

(71) Applicant: QSA Global Inc., Burlington, MA (US)

(72) Inventor: Ryan Trulli, Billerica, MA (US)

(21) Appl. No.: 19/216,223

(22) Filed: May 22, 2025

Related U.S. Application Data
(60) Provisional application No. 63/651,135, filed on May 23, 2024.

(51) Int. Cl. G21F 5/015; G01N 23/04; G01S 19/14; G21F 5/04

(52) U.S. Cl. CPC G21F 5/015; G01N 23/04; G01S 19/14; G21F 5/04; G01N 2223/308

(57) ABSTRACT

Disclosed example radiographic source projectors include: a source housing configured to house a radiographic source capsule and to selectively expose the radiographic source capsule for radiographic imaging; a jacket holding the source housing and comprising a handle for carrying the source housing; and a removable tracker module; and a tracker module holder configured to accept the removable tracker module and to retain the removable tracker module within a cavity of the jacket.

### RELATED APPLICATIONS

The present application claims the benefit of U.S. Provisional Patent Application Ser. No. 63/651,135, filed May 23, 2024, entitled “RADIOGRAPHY SOURCES AND RADIATION EXPOSURE DEVICES HAVING TRACKER MODULE HOLDERS.” The entirety of U.S. Provisional Patent Application Ser. No. 63/651,135 is expressly incorporated herein by reference.

### FIELD OF THE DISCLOSURE

This disclosure relates generally to radiography and, more particularly, to radiography sources and radiation exposure devices having tracker module holders.

### BACKGROUND

Industrial radiography is often used for producing images of objects that are otherwise difficult to inspect, and involves exposing a source of high-energy radiation (e.g., gamma rays) and collecting penetrating and/or scattered rays to form a radiographic image. When not in use, gamma ray sources, such as radioactive isotopes, are stored in shielding devices.

### SUMMARY

Radiography sources and radiation exposure devices having keyed locking devices are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIGS. 1A and 1B illustrate an example radiography system having a source exposure device for providing radiation for radiography, in accordance with aspects of this disclosure.

FIGS. 2A and 2B illustrate another example radiography system having a source projector device for providing radiation for radiography, in accordance with aspects of this disclosure.

FIG. 3 is a perspective view of an example radiography system that may implement the radiography system of FIGS. 2A and 2B including a tracker module and a tracker module holder.

FIG. 4 is a partially exploded view of the example radiography system of FIG. 3.

FIGS. 5 and 6 are perspective views of the example tracker module holder of FIG. 3.

FIG. 7 is a perspective view of the example tracker module of FIG. 4 stored in the tracker module holder.

The figures are not necessarily to scale. Wherever appropriate, similar or identical reference numerals are used to refer to similar or identical components.

### DETAILED DESCRIPTION

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

Disclosed example radiographic source projectors include: a source housing configured to house a radiographic source capsule and to selectively expose the radiographic source capsule for radiographic imaging; a jacket holding the source housing and comprising a handle for carrying the source housing; a removable tracker module; and a tracker module holder configured to accept the removable tracker module and to retain the removable tracker module within a cavity of the jacket.

In some example radiographic source projectors, the jacket includes a foot configured to support the jacket and the source housing in a stable position on a surface, in which the cavity of the jacket is at least partially within the foot. In some example radiographic source projectors, the tracker module holder includes a slot configured to accept the removable tracker module. In some example radiographic source projectors, the tracker module holder is configured to fit at least partially within the cavity such that an opening of the slot faces at least one of the jacket or the source housing. In some example radiographic source projectors, the slot is configured to accept the removable tracker module with a clearance fit.

In some example radiographic source projectors, the removable tracker module is a commercial off-the-shelf tracker module. In some example radiographic source projectors, the removable tracker module is configured to wirelessly communicate an identifier of the removable tracker module to an external computing device. Some example radiographic source projectors further include a second module holder configured to accept an object and to retain the object within a second cavity of the jacket. In some example radiographic source projectors, the second module holder is configured to accept at least one of a key or a connector.

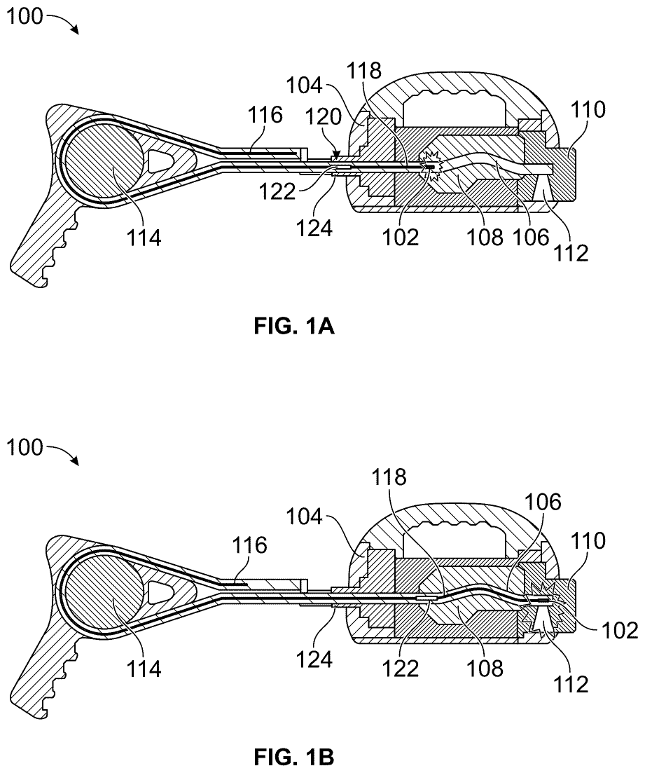

FIGS. 1A and 1B illustrate an example radiographic source projector 100 having a source projector for emitting radiation to perform radiography. The radiographic source projector 100 includes a radiographic source capsule 102 (also referred to herein as a radiation source) which is contained within a radiography source housing 104 (also referred to as a package). The example housing 104 is configured to meet the requirements of a Type A and B package under the International Atomic Energy Agency Safety Standards, Regulations for the Safe Transport of Radioactive Material, 2012 and 2018 Editions, No. SSR-6.

The example radiographic source capsule 102 includes a radiographic source capsule including a sealed radiographic material. The sealed radiographic material may include Iridium-192, Cobalt-60, Caesium-137, Ytterbium-169, Thallium-201, Hafnium-175 (or thermal neutron-irradiated Hafnium-174), and/or any other radiography isotope which emits radiation (e.g., gamma rays, X-rays, etc.) due to decay of the material.

The radiographic source capsule 102 is positioned in a radiographic source passage 106 (e.g., a source tube) within a shield 108 within the housing 104. The radiographic source passage 106 may be a tungsten-based tube, and the example shield 108 is a depleted uranium-based shield. However, other radiographic source passage 106 materials and/or shielding materials may be used. When positioned in a stored position as shown in FIG. 1A, emissions from the radiographic source capsule 102 are shielded by the shield 108. As an end of the shield 108, the radiographic source passage 106 and shield are connected to an outlet port 110 or collimator. The outlet port 110 may be a similar shielding material as the shield 108, but includes an aperture 112 through which radiation emissions may be projected from the radiographic source projector 100 in a desired direction.

The example radiographic source capsule 102 is assembled into a radiographic source assembly 120 with a drive cable 118 and a control connector 122.

To project gamma rays for radiography, the example radiographic source capsule 102 is moved via the radiographic source passage 106 into a projection position within the outlet port 110 and adjacent the aperture 112, as illustrated in FIG. 1B. For example, a remote control 114 may be removably attached to the radiographic source capsule 102 to control a position of the radiographic source capsule 102 (e.g., the stored position, the projection position). For example, the remote control 114 may physically engage the control cable 116 to advance or retract the control cable 116 relative to the remote control 114. By connecting the remote control 114 to the source capsule 102 via a control cable 116, the remote control 114 may be manipulated (e.g., cranked) to push or pull the radiographic source capsule 102 to a desired position within the housing 104.

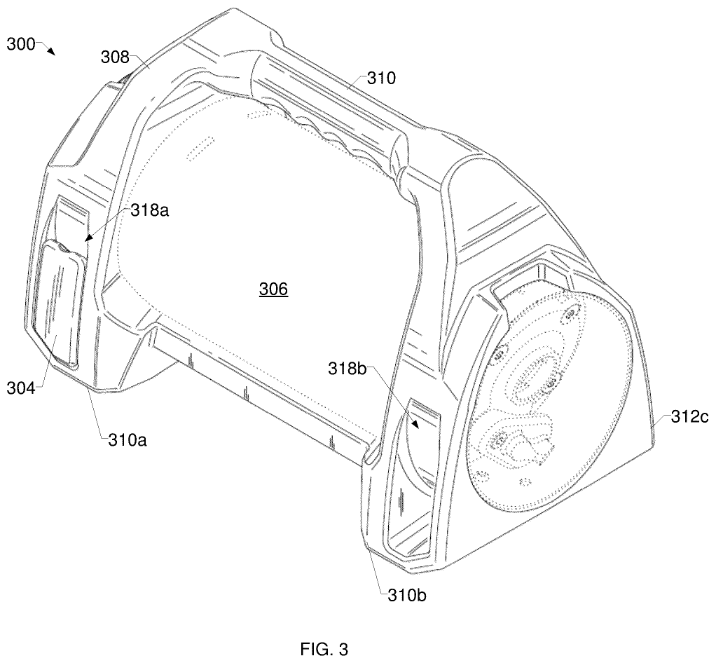

To control the position of the radiographic source capsule 102, the radiography source housing 104 enables connection of the control cable 116 to the radiographic source capsule 102 for exposure and retraction of the radiographic source capsule 102. The control cable 116 may be physically attached or connected to a drive cable 118 via a control connector 122. A distal end of the drive cable 118 is attached to the radiographic source capsule 102, and a proximal end of the drive cable 118 is attached to the control connector 122. The control connector 122 is removably connectable to the control cable 116 via a remote connector, as illustrated in FIG. 3B described below.

When engaged, the control cable 116 is controlled to extend into and through the radiographic source passage 106 to push the radiographic source capsule 102 to an exposed position adjacent the aperture 112. Conversely, the control cable 116 is retracted to pull the radiographic source capsule 102 from the exposed position back into the radiographic source passage 106 to the shielded position, at which time the control cable 116 may be detached from the radiographic source capsule 102.

A connector lock assembly 124 holds the radiographic source assembly 120 in position within the shield 108 to allow compliance with governmental regulations for conveyance of the radiographic source projector 100. The remote connector is configured to allow for unlocking of the connector lock assembly 124 and exposure of the radiographic source capsule 102 when the control cable 116 is securely connected to allow for full retraction and locking of the radiographic source assembly 120.

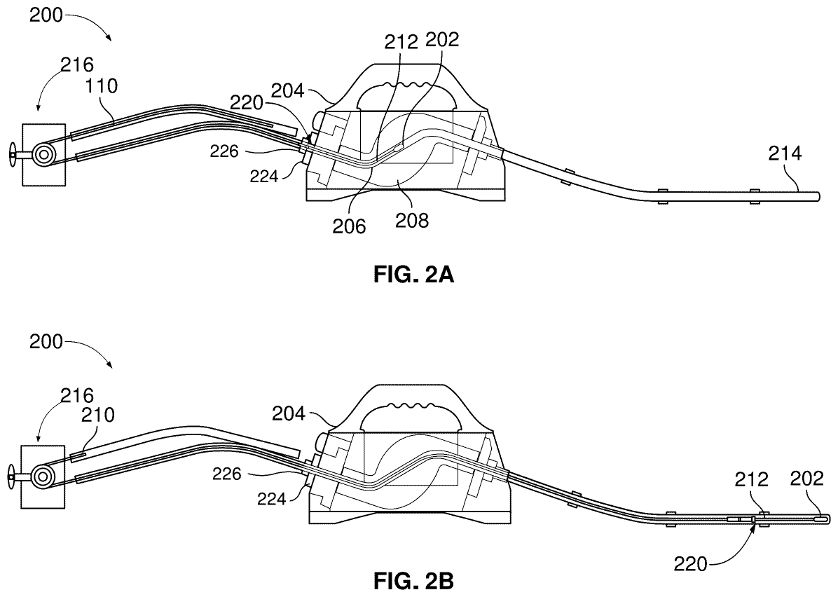

FIGS. 2A and 2B illustrate another example radiographic source projector 200 for providing radiation for radiography. The radiographic source projector 200 of FIG. 2 includes a radiographic source capsule 202 which is contained within a radiography source housing 204. the radiographic source capsule 202 may be similar or identical to the example radiographic source capsule 102 disclosed above, and emits radiation (e.g., X-rays, gamma rays) due to decay of the material. In contrast with the example projector of FIGS. 1A and 1B, the example radiographic source projector 200 of FIGS. 2A and 2B extend the source capsule 202 to a position external to the housing 204 for exposing the source capsule 202, which may require larger exclusion zones during radiography than the example radiographic source projector 100 of FIGS. 1A and 1B.

The radiography source housing 204 includes a radiographic source passage 206 (e.g., an S-shaped source tube) within a shield 208. The radiographic source passage 206 provides a pathway for the radiographic source capsule 202 to be exposed to an exterior of the shield 208, which in this example is constructed from depleted uranium, and retracted to a shielded position within the interior of the shield 208. FIG. 2A illustrates the radiographic source capsule 202 in the shielded position, and FIG. 2B illustrates the radiographic source capsule 202 in an exposed position.

The example radiographic source capsule 202 is part of a radiographic source assembly 220, which also includes a drive cable 212 and a control connector 222. The position of the radiographic source capsule 202 may be controlled via a control cable 210 and remote control 216 similar to the control cable 116 and the remote control 114 of FIGS. 1A and 1B. The control cable 210 is connected to the control connector 222 and to the radiographic source capsule 202.

The example radiographic source projector 200 further includes a connector lock assembly 224, which connects to a remote connector lock 226 of the remote control 216.

In the radiographic source projector 200 of FIGS. 2A and 2B, the exposed position of the radiographic source capsule 202 may be controlled by a guide tube 214, through which the radiographic source capsule 202 travels as the source capsule 202 is pushed by the control cable 210. The control cable 210 has sufficient column strength to push the radiographic source capsule 202 through the radiographic source passage 206 and through the guide tube 214.

Owners and operators of radiographic source projectors such as the projectors 100, 200 of FIGS. 1A, 1B, 2A, and 2B desire to know where the projectors 100, 200 are located at any given time. The location may be important, for example, for selecting the correct source projector for an intended radiographic operation, determining which source projector is the nearest to the location of a radiographic operation to be performed, and/or locating a misplaced source projector. While conventional source projectors have had tracking units attached using zip ties, such arrangements are subject to the loss of, or damage to, the tracking unit in heavy industrial environments in which source projectors are commonly subjected.

FIG. 3 is a perspective view of an example radiography system 300 that may implement the radiography source projector 200 of FIGS. 2A and 2B including a tracker module 302 and a tracker module holder 304. The example tracker module 302 and the tracker module holder 304 provide a secure and protected storage for the tracker module 302 that mitigates the risk of damage or loss to the tracker module 302, while also allowing for easy insertion and/or removal of the tracker module when desired.

The example radiography system 300 includes a housing 306, which may implement the radiography source housing 204 of FIG. 2, and include the radiographic source assembly 220, the radiographic source capsule 202, the radiographic source passage 206, the shield 208, and the connector lock assembly 224.

The housing 306 is at least partially encompassed by a jacket 308. The jacket 308 holds the source housing 306, and includes a handle 310 for carrying the source housing 306. The jacket 308 may provide protective features and/or stabilizing features. For example, the jacket 308 includes feet 312a-312c which support and/or stabilize the radiography system 300 when placed on a surface.

The example tracker module 302 is an off-the-shelf commercial location tracker, such as an Apple® AirTag® accessory, a Tile® Pro tracker, a ONE-KEY™ tracker sold by Milwaukee Electric Tool Corporation, or any other off-the-shelf commercial or custom location tracker. The tracker module 302 communicates an identifier of the tracker module 302 (e.g., a serial number, a name, a MAC address, or other unique identifier) to an external computing device 314, such as via near-field communications (NFC) or other short-range wireless communications (e.g., Bluetooth® wireless communications). Additionally or alternatively, the tracker module 302 may be an identifier tag, such as an RFID tag, an NFC tag, or any other active or passive close-proximity communications transponder having an identifier.

The external computing device 314 may determine the location of the tracker module 302 using a location of the external computing device 314, and store and/or communicate the location of the tracker module 302 to other devices (e.g., to a fleet management system). The example external computing device 314 may be a smartphone, a tablet computer, a laptop computer, a wireless communications hub or access point, and/or any other portable computing device capable of communication with the tracker module 302.

In some other examples, the tracker module 302 is a position-determining tracker, such as a GPS positioning module capable of communicating an identifier and a determined location to the external computing device 314.

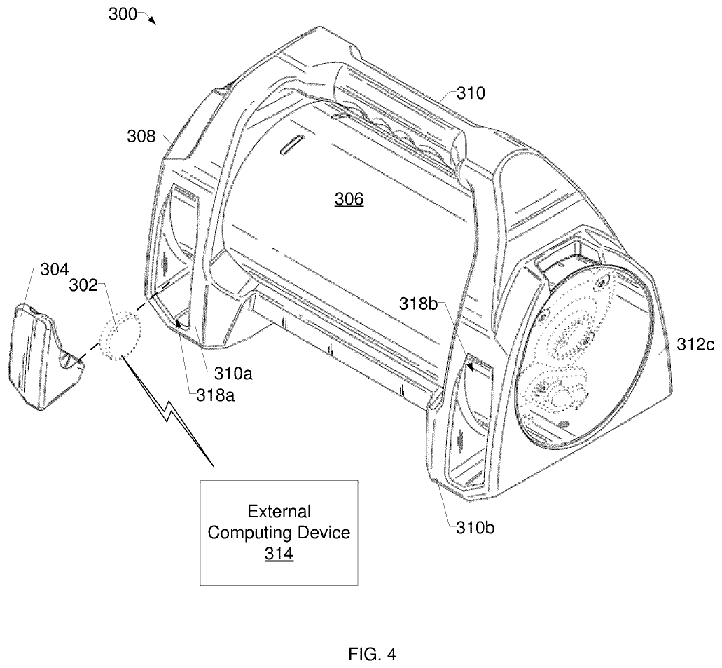

The example tracker module holder 304 is configured to accept the removable tracker module 302 and to retain the removable tracker module 302 within a cavity of the jacket 308. As illustrated in FIG. 4, the tracker module holder 304 may include a tracker slot 316 dimensioned to fit the tracker module 302, which is then held in place by installing the tracker module holder 304 into the jacket 308. In the example of FIG. 3, the example feet 312a-312c of the jacket 308 include respective cavities 318a-318d. The tracker module holder 304, with the tracker module 302 inserted, may be placed into one of the cavities 318a-318d to retain the tracker module 302 with the radiography system 300 for tracking of the location of the radiography system 300. The tracker module holder 304 fits at least partially within at least one of the cavities 318a-318d, such that an opening of the tracker slot 316 faces at least one of the jacket 308 or the source housing 306. For example, the tracker module 302 within the tracker slot 316 is retained between the tracker module holder 304 on a first side and the housing 306 and/or the jacket 308 on the second side.

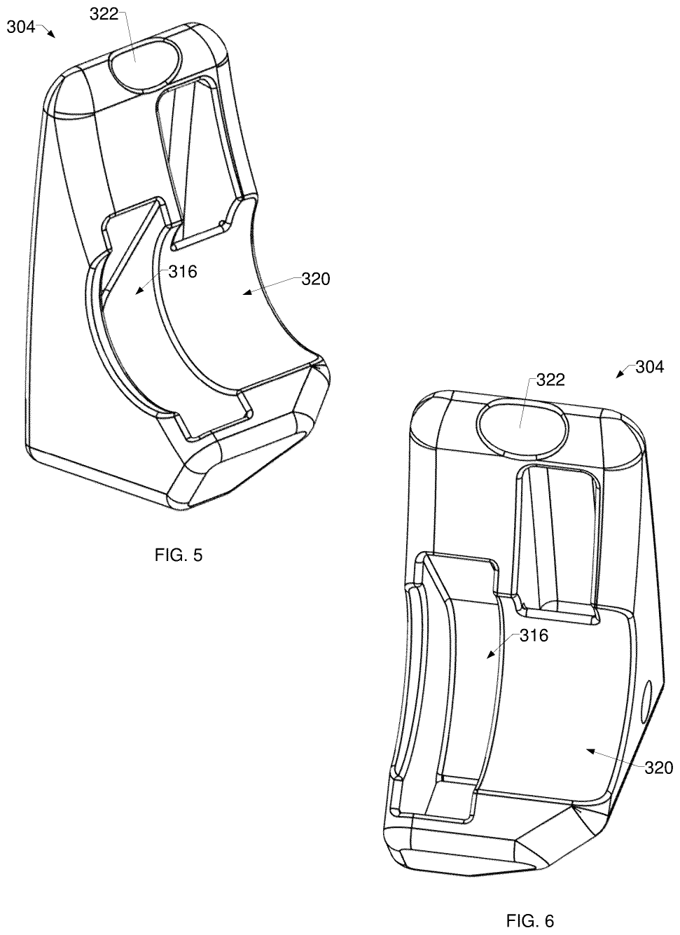

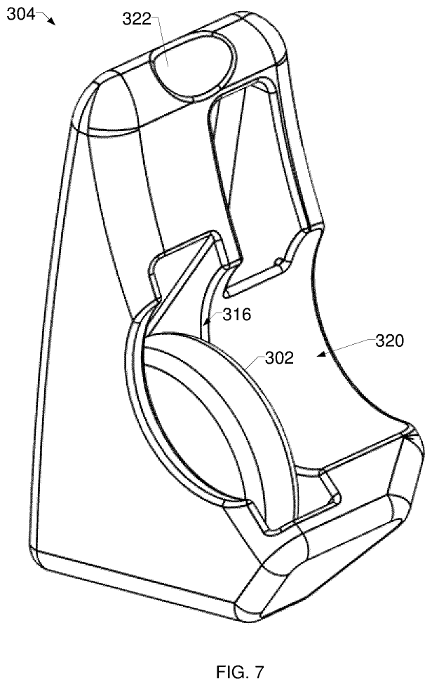

FIGS. 5 and 6 are perspective views of the example tracker module holder 304 of FIG. 3. FIG. 7 is a perspective view of the example tracker module 302 of FIG. 4 stored in the tracker module holder 304. The example slot 316 is dimensioned to closely fit an Apple® AirTag® accessory. For example, the slot 316 may be dimensioned for a clearance fit of the tracker module 302 so that the tracker module 302 may be easily inserted and removed from the slot 316. The clearance fit reduces the amount of travel and impact experienced by the tracker module 302 while the radiography system 300 is transported and/or handled. However, the slot 316 may be dimensioned for a friction fit, may include a retention strap or other retention device to prevent movement of the tracker module 302 within the slot 316, and/or may be dimensioned to fit one or more other types of tracker modules.

The tracker module holder 304 may be constructed using a thermoset or thermoelastic plastic, or other desired material. In some examples, the tracker module holder 304 deforms (e.g., compresses) slightly when inserted into the cavity 318a to provide a holding force that resists removal of the tracker module holder 304 from the cavity 318a. In some other examples, the tracker module holder 304 is rotationally coupled to the jacket 308, such that the tracker module holder 304 rotates open to accept or remove the tracker module 302, and rotates closed to retain the tracker module 302. In some examples, the tracker module holder 304 and/or the jacket 308 include one or more detents or other retention features to resist removal of the tracker module holder 304.

As illustrated in FIG. 7, the tracker module holder 304 further includes a tracker removal slot 320 and a holder removal groove 322. The tracker removal slot 320 allows for a user to grasp the tracker module 302 from the sides of the tracker module 302 to remove the tracker module 302 from the tracker slot 316. The holder removal groove 322 allows a user to grasp and remove (e.g., pry) the tracker module holder 304 while installed in the cavity 318a.

In some other examples, the tracker module holder 304 may include additional or alternative pockets or slots for other objects associated with the projector 200. For example, the tracker module holder 304 may be configured to hold or store a connector to perform a functionality check on the connector lock assembly 324, a key to unlock the connector lock assembly, or any other objects or equipment which could fit within the cavities 318a-318c. In some examples, multiple ones of the cavities 318a-318c may include tracker module holders 304, or object holders having similar profiles and differently sized slots or pockets for holding different objects.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made, and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A radiographic source projector, comprising:
a source housing configured to house a radiographic source capsule and to selectively expose the radiographic source capsule for radiographic imaging;
a jacket holding the source housing and comprising a handle for carrying the source housing;
a removable tracker module; and
a tracker module holder configured to accept the removable tracker module and to retain the removable tracker module within a cavity of the jacket.

2. The radiographic source projector as defined in claim 1, wherein the jacket comprises a foot configured to support the jacket and the source housing in a stable position on a surface, wherein the cavity of the jacket is at least partially within the foot.

3. The radiographic source projector as defined in claim 1, wherein the tracker module holder comprises a slot configured to accept the removable tracker module.

4. The radiographic source projector as defined in claim 3, wherein the tracker module holder is configured to fit at least partially within the cavity such that an opening of the slot faces at least one of the jacket or the source housing.

5. The radiographic source projector as defined in claim 3, wherein the slot is configured to accept the removable tracker module with a clearance fit.

6. The radiographic source projector as defined in claim 1, wherein the removable tracker module is a commercial off-the-shelf tracker module.

7. The radiographic source projector as defined in claim 1, wherein the removable tracker module is configured to wirelessly communicate an identifier of the removable tracker module to an external computing device.

8. The radiographic source projector as defined in claim 1, further comprising a second module holder configured to accept an object and to retain the object within a second cavity of the jacket.

9. The radiographic source projector as defined in claim 1, wherein the second module holder is configured to accept at least one of a key or a connector.
